(19) United States
(12) Patent Application Publication
(10) Pub. No.: US 2001/0024965 A1
(43) Pub. Date: Sep. 27, 2001

(54) Mobile communication terminal and ringing method thereof

(76) Inventor: Keiichi Hayashi, Kanagawa (JP)

Correspondence Address: SUGHRUE, MION, ZINN, MACPEAK & SEAS, 2100 Pennsylvania Avenue, N.W., Washington, DC, 20037, US

(21) Appl. No.: 09/759,220

(22) Filed: Jan. 16, 2001

(30) Foreign Application Priority Data
Jan. 21, 2000 (JP) 017751/2000

(51) Int. Cl. H04M 1/00

(52) U.S. Cl. 455/567; 455/557

(57) ABSTRACT

A mobile communication terminal and its ringing method are provided for sounding an incoming ring tone and a tone for notifying reception of an e-mail in various tones. A portable telephone serving as the mobile communication terminal includes an operating part, a timer, a memory, a display, a display controller, an interface, a tone generator, a speaker and a controller. The tone generator changes settings of ringing tones based on tone information contained in melody data fetched from a server equipment and stored in the memory. It is therefore possible to play melodies in accordance with desired incoming ring tone patterns in various tones, based on user settings entered from the operating part.

### BACKGROUND OF THE INVENTION

The present invention relates to a mobile communication terminal and its ringing method. More particularly, the invention relates to a mobile communication terminal and its ringing method provided with the capabilities to change settings of an incoming ring tone and other tones.

### Description of the Related Art

In a conventional portable telephones serving as mobile communication terminals, ring tone patterns stored in the internal memory are changed based on the information entered by a user by using control keys. These telephones then sound a tone associated with these patterns when there is an incoming call or an e-mail is received by means of a mail function.

In addition to the ring tone patterns stored in advance in the internal memory and desired ring tone patterns entered (created or edited) by the user, some portable telephones are recently known which download new ring tone patterns as melody data from a server equipment by using a browser function and store the patterns in the memory to set an incoming ring tone and a tone for notifying an incoming e-mail.

However, the conventional mobile communication terminals described above simply play a melody according to ring tone patterns stored in a memory in a fixed tone (that is, an electronic sound), thus resulting in a simple and monotonous melody which lacks expressive power.

Although the conventional terminals have the capability to change tone settings, there is a cumbersome task of keeping tone-related data in the memory and changing the data for each musical piece. Besides, the number of tones that can be expressed is limited by memory capacity.

### SUMMARY OF THE INVENTION

It is an object of the present invention to provide a mobile communication terminal and its ringing method capable of setting downloaded tone information as an incoming ring tone and a tone for notifying reception of an e-mail without being limited by memory capacity.

Another object of the present invention is to provide a mobile communication terminal and its ringing method capable of setting a variety of tones.

To solve the above described problem, the present invention as set forth in claim 1 is a mobile communication terminal equipped with a browser function comprises means for fetching melody data from a server apparatus by using said browser function; and tone setting means for setting ringing tones based on tone information contained in said melody data.

The invention as set forth in claim 2, is characterized in that in the invention as set forth in claim 1, if said melody data contains no tone information, said tone setting means sets a ringing tone based on preset tone information.

The invention as set forth in claim 3, is characterized in that in the invention as set forth in claim 1, if said melody data contains tone information, said tone setting means judges the validity of said tone information.

The invention as set forth in claim 4, is characterized in that in the invention as set forth in claim 3, said tone setting means sets ringing tones by performing a modulation processing based on said tone information contained in said melody data.

The invention as set forth in claim 5, is characterized in that in the invention as set forth in claim 4, said tone information contained in said melody data constitutes tone parameters used for said modulation processing.

The invention as set forth in claim 6, is characterized in that in the invention as set forth in claim 2, further comprises ringing-speed setting means for setting a tempo at which a melody is played in accordance with said melody data.

The invention as set forth in claim 7, is characterized in that in the invention as set forth in claim 5, further comprises ringing-speed setting means for setting a tempo at which a melody is played in accordance with said melody data.

A ringing method for a mobile communication terminal equipped with a browser function, in accordance with the invention as set forth in claim 8, comprises the steps of: having access to a server equipment by means of said browser function; notifying said server equipment of desired melody data in conformity with said access; receiving said desired melody data from said server equipment; storing said desired melody data received in said receiving step; judging whether said melody data stored in said storing step contains tone information; fetching said tone information if said judging step judges that said melody data contains the tone information; setting a tone for playing a melody in accordance with said melody data, based on said tone information fetched in said fetching step; and playing said melody in said tone set in said setting step.

The invention as set forth in claim 9, is characterized in that in the invention as set forth in claim 8, if said melody data contains no tone information, said tone setting step sets a ringing tone based on preset tone information.

The invention as set forth in claim 10, is characterized in that in the invention as set forth in claim 8, if said melody data contains tone information, said tone setting step judges the validity of said tone information.

The invention as set forth in claim 11, is characterized in that in the invention as set forth in claim 10, said tone setting step sets ringing tones by performing a modulation processing based on said tone information contained in said melody data.

The invention as set forth in claim 12, is characterized in that in the invention as set forth in claim 11, said tone information contained in said melody data constitutes tone parameters used for said modulation processing.

The invention as set forth in claim 13, is characterized in that in the invention as set forth in claim 9, further comprises a ringing-speed setting step of setting a tempo at which a melody is played in accordance with said melody data.

The invention as set forth in claim 14, is characterized in that in the invention as set forth in claim 12, further comprises a ringing-speed setting step of setting a tempo at which a melody is played in accordance with said melody data.

### BRIEF DESCRIPTION OF THE DRAWINGS

The objects and features of the present invention will become more apparent from the consideration of the following detailed description taken in conjunction with the accompanying drawings, in which:

FIG. 1 is a conceptual diagram showing a melody-data delivery system according to an embodiment of the present invention;

FIG. 2 is a block diagram showing a schematic configuration of a mobile communication terminal according to the embodiment of the present invention; and

FIG. 3 is a flowchart showing an example of operations with respect to setting tones and sounding an incoming ring tone on the mobile communication terminal according to the embodiment of the present invention.

### DESCRIPTION OF THE PREFERRED EMBODIMENTS

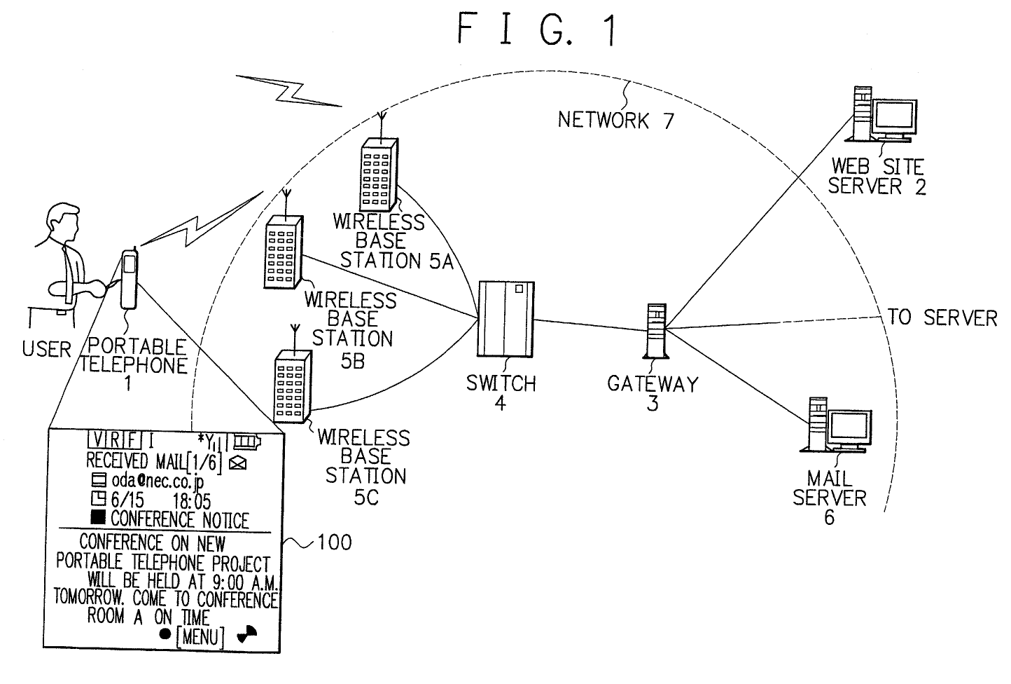

A mobile communication terminal and its ringing method according to an embodiment of the present invention will now be described in detail with reference to the accompanying drawings. FIGS. 1 to 3 show the embodiment of the mobile communication terminal and a method of sounding an incoming ring tone on the terminal according to the present invention.

FIG. 1 is a conceptual diagram showing a melody-data (ringing tone patterns) delivery system for the mobile communication terminal according to the embodiment of the present invention. As shown in FIG. 1, the melody-data delivery system according to the present embodiment forms a network 7 comprising a portable telephone 1 owned by a user, which serves as a mobile communication terminal, a Web-site server 2 for managing the melody data to be delivered, a gateway 3, a switch 4, wireless base stations 5A to 5C and a mail server 6.

In the system, when the user initially starts communications with the wireless base station 5B for requiring to obtain melody data, by using a browser function equipped in his/her portable telephone 1, the base station 5B completes access to the Web site server 2 through the gateway 3 and switch 4.

The Web site server 2 then delivers the melody data requested by the user to the portable telephone 1 through the gateway 3, the switch 4 and the wireless base station 5B.

The mail server 6 is a server equipment which manages e-mails sent to the address set for the portable telephone 1 as well as e-mails sent by the use of the portable telephone 1.

The melody data (incoming ring tone patterns) thus delivered is stored in a memory 13 (which will be described below) of the portable telephone 1 and the data is used for sounding an incoming ring tone based on user settings when there is an incoming call or an e-mail is received.

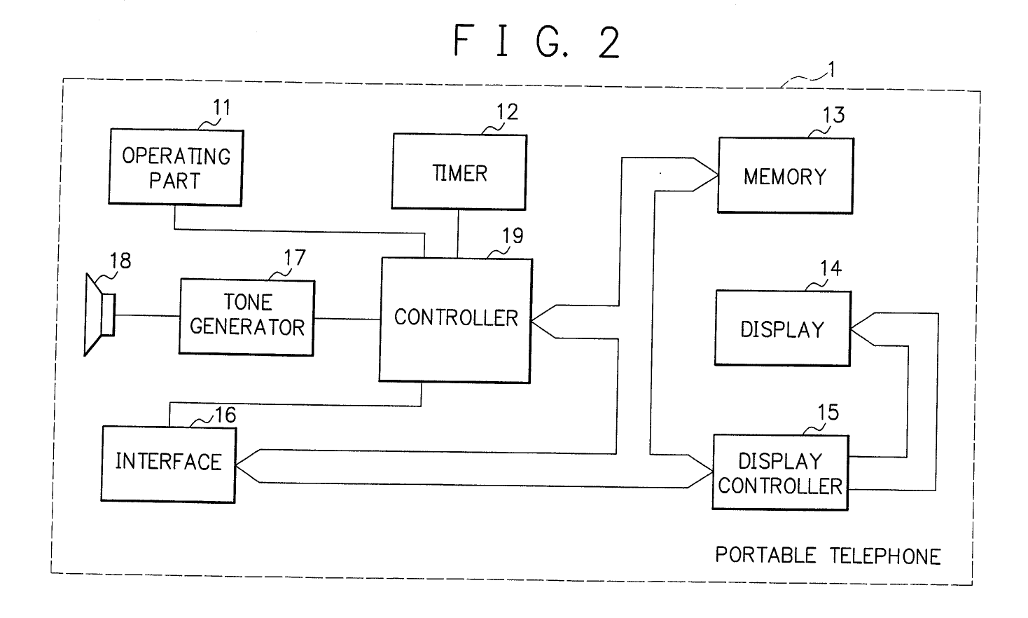

FIG. 2 is a block diagram showing a schematic configuration of the mobile communication terminal according to the present embodiment. In FIG. 2, the portable telephone 1 serving as the mobile communication terminal according to the present embodiment, is configured by an operating part 11, a timer 12, a memory 13, a display 14, a display controller 15, an interface 16, a tone generator 17, a speaker 18 and a controller 19.

The operating part 11 comprises a plurality of control keys (not shown) for use by the user to enter telephone numbers, e-mail addresses, e-mail documents composed of characters, symbols, numerals, etc., various functional assignments or the like.

The timer 12 is provided with a clock function to the portable telephone 1 and is used to set alarms and count elapsed time of a call or the like.

The memory 13 as described above, stores incoming ring tone patterns delivered by the Web server or the like, incoming ring tone patterns created and edited by the user, information on the telephone numbers and e-mail addresses registered by the user and other information related to memos, as well as a control program for various operation settings.

The display 14 visually displays information about the various settings made by the user via the operating part 11, the telephone numbers entered, character information during preparation of an e-mail, information about received e-mails and the like. The use of a TFT-LCD (thin film transistor-color liquid crystal display) will increase the visibility of a screen on the display 14.

One example of a received e-mail displayed on the display 14 is partly shown in FIG. 1 with a reference numeral 100.

The display controller 15 controls the display 14 to change over contents displayed on the display 14 in synchronization with timings of inputs from the operating part 11. The display controller 15 changes over display timings, it also performs adjustment controls, such as adjustment of display densities and, if a color liquid crystal display is used as described above, adjustment of grays of color or the like.

Peripheral devices, for example, a personal computer and an external keyboard can be connected to the interface 16, thereby enabling to send e-mails and to connect to the Internet, by using communications functions of the portable telephone 1.

With a help of the controller 19, the tone generator 17 fetches tone data (tone information) specified in the melody data, that is, incoming ring tone patterns, which has been delivered from the Web server 2 and stored in the memory 13. The tone generator 17 then sets the actual playing speed (tempo) of a melody or tune to be played through the speaker 18 conforming to the melody data, which indicates the setting of a tone associated with the melody data.

The tone generator 17 produces various tones such as tones of various musical instruments by performing a modulation processing based on tone parameters in the melody data stored in the memory 13.

The controller 19 controls operations of the parts described above based on the control program stored in the memory 13. The controller 19 also executes controls of various operations based on the user settings entered from the operating part 11.

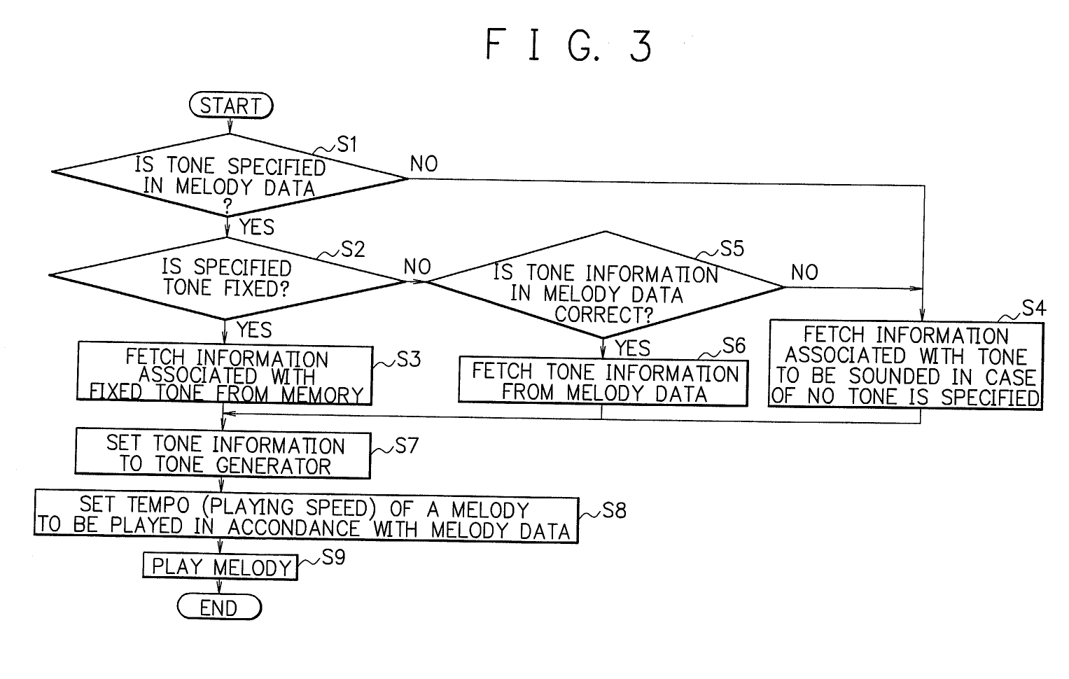

FIG. 3 is a flowchart showing an example of operations such as a tone setting and a ringing operation on the mobile communication terminal according to the embodiment of the present invention. In step S1 of FIG. 3, when the mobile communication terminal receives a call or e-mail, the controller 19 of the terminal checks as to whether melody data stored in the memory has tone specifications (tone parameters).

If the melody data has the tone specification (YES in Step S1), it is checked in step S2 whether the specified tone is a fixed tone. If YES is rendered in step S2, that is, in a case where the specified tone is a fixed tone, information or data corresponding to the fixed tone is fetched from the memory (Step S3), then the processing goes to Step S7.

If it is determined in step S1 that the melody data has no tone specifications, the controller 19 fetches from the memory information or data corresponding to a tone which will be sounded when there is no tone specification (step S4). The controller 19 then advances processing to step S7.

If it is determined in step S2 that the specified tone is not a fixed tone, a check is made in step S5 as to whether the tone information contained in the melody data is correct. If it is correct (YES in step S5), the controller 19 fetches the tone information in the melody data (step S6). The processing then goes to step S7.

Alternatively, if a determination is made in step S5 that the tone information in the melody data is not correct, the processing goes to step S4 where the controller 19 fetches from the memory information or data corresponding to a tone to be sounded when there is no tone specification. The processing then goes to step S7.

In step S7, the tone information which has been fetched in step S3, S4 or S6 is set to the tone generator 17. Tempo (a playing speed in other words) of a melody to be played in association with the melody data is also set in step S8. After these settings, the melody is played in step S9.

The embodiment described above is a preferred embodiment of the present invention. Various modifications may be made without departing from the spirit of the present invention. Other possible embodiments of the present invention will be described below.

The present invention can be applied to, for example, a portable e-mail terminal or the like which can download melody data from a server equipment and set the downloaded data as data corresponding to a ringing tone which will be sounded when the terminal receives an e-mail. In such terminal, tone information is specified when the terminal sounds the ringing tone in accordance with a melody, upon reception of an e-mail or when the terminal plays a music at a time when an e-mail is opened, in accordance with melody data attached to the e-mail. Thereby, it is possible to play melodies in a rich tone when an e-mail is received or opened.

It is also possible to play various melodies in rich tones without keeping tone information in the mobile communication terminal, because the tones are specified directly together with data to be used for ringing a tone.

As apparent from the above description, the mobile communication terminal and its ringing method according to the present invention enable to sound an incoming ring tone in various tones when there is an incoming call or an e-mail arrives, which results in making it possible to play melodies expressively.

The mobile communication terminal and its ringing method according to the present invention dynamically change the tone of melodies to be played when a call is received. Such operation reduces the amount of memory taken up by the tone information.

Furthermore, the mobile communication terminal and its ringing method according to the present invention change the tone dynamically, therefore it is possible to eliminate inconvenience of setting the tone anew for each musical piece while allowing the tone to be set for each phrase or each scale when a single musical piece is played.

What is claimed is:

1. A mobile communication terminal equipped with a browser function, comprising:
means for fetching melody data from a server apparatus by using said browser function; and
tone setting means for setting ringing tones based on tone information contained in said melody data.

2. The mobile communication terminal according to claim 1, wherein if said melody data contains no tone information, said tone setting means sets a ringing tone based on preset tone information.

3. The mobile communication terminal according to claim 1, wherein if said melody data contains tone information, said tone setting means judges the validity of said tone information.

4. The mobile communication terminal according to claim 3, wherein said tone setting means sets ringing tones by performing a modulation processing based on said tone information contained in said melody data.

5. The mobile communication terminal according to claim 4, wherein said tone information contained in said melody data constitutes tone parameters used for said modulation processing.

6. The mobile communication terminal according to claim 2, further comprising:
ringing-speed setting means for setting a tempo at which a melody is played in accordance with said melody data.

7. The mobile communication terminal according to claim 5, further comprising:
ringing-speed setting means for setting a tempo at which a melody is played in accordance with said melody data.

8. A ringing method for a mobile communication terminal equipped with a browser function, comprising the steps of:
having access to a server equipment by means of said browser function;
notifying said server equipment of desired melody data in conformity with said access;
receiving said desired melody data from said server equipment;
storing said desired melody data received in said receiving step;
judging whether said melody data stored in said storing step contains tone information;
fetching said tone information if said judging step judges that said melody data contains the tone information;
setting a tone for playing a melody in accordance with said melody data, based on said tone information fetched in said fetching step; and
playing said melody in said tone set in said setting step.

9. The ringing method for a mobile communication terminal according to claim 8, wherein if said melody data contains no tone information, said tone setting step sets a ringing tone based on preset tone information.

10. The ringing method for a mobile communication terminal according to claim 8, wherein if said melody data contains tone information, said tone setting step judges the validity of said tone information.

11. The ringing method for a mobile communication terminal according to claim 10, wherein said tone setting step sets ringing tones by performing a modulation processing based on said tone information contained in said melody data.

12. The ringing method for a mobile communication terminal according to claim 11, wherein said tone information contained in said melody data constitutes tone parameters used for said modulation processing.

13. The ringing method for a mobile communication terminal according to claim 9, further comprising a ringing-speed setting step of setting a tempo at which a melody is played in accordance with said melody data.

14. The ringing method for a mobile communication terminal according to claim 12, further comprising a ringing-speed setting step of setting a tempo at which a melody is played in accordance with said melody data.
